(19) United States
(12) Patent Application Publication
(10) Pub. No.: US 2007/0031143 A1
(43) Pub. Date: Feb. 8, 2007

(54) Overhead camera support apparatus

(76) Inventor: Gregory Riccardi, Ridgewood, NJ (US)

Correspondence Address: Mr. Gregory Riccardi, 330 South Pleasant Avenue, Ridgewood, NJ, 07450, US

(21) Appl. No.: 11/499,954

(22) Filed: Aug. 7, 2006

Related U.S. Application Data
(60) Provisional application No. 60/705,897, filed on Aug. 5, 2005.

(51) Int. Cl. G03B 17/00

(52) U.S. Cl. 396/420

(57) ABSTRACT

An overhead camera support apparatus includes a lower horizontal member having a first end and a second end; at least two vertical legs, each leg having an upper end and a lower end, the lower end of each leg being connected to the first end and the second end of the lower horizontal member; a shoulder member connected to the upper end of each of the at least two vertical legs; and an upper vertical member connected to the shoulder member.

### CROSS-REFERENCE TO RELATED APPLICATION

This non-provisional application claims priority to provisional application No. 60/705,897, filed on Aug. 5, 2005, the entire contents of which is incorporated herein by reference.

### TECHNICAL FIELD

This invention is directed to an overhead camera support apparatus, and in particular, to an apparatus that is easily mounted on a person's shoulders to aid in videotaping.

### BACKGROUND OF THE INVENTION

The inventor of the overhead camera support apparatus, otherwise known and referred to hereinafter as the “Elevator,” has been a professional videographer for more than 20 years. He has videotaped hundreds of weddings, corporate events, anniversary celebrations and family events, and has a significant amount of experience using various professional video cameras. The inventor has identified a number of problems when videotaping an event using a professional video camera. First, a professional video camera typically weighs at least 15-20 pounds. In use, it typically rests on and is supported by the videographer's right shoulder. The constant lifting and removing of the video camera onto/from the videographer's right shoulder takes a toll on the videographer's shoulder and back, and can cause severe pain and possible injury when used over a prolonged period of time. Second, since the camera is not transparent, the videographer's vision is completely blocked on one side, e.g., the right side if the videographer holds the videocamera on his right shoulder. Since the purpose of using a video camera is to record anything that is happening around you, having your sight limited to less than 50% is a severe handicap. Third, the camera-mounted lighting is bothersome to those being videotaped. Fourth, the height of the video shot is limited to the height of the videographer using the camera. For this reason, it is quite common to see a videographer use a cumbersome tripod, stand on a ladder or chair, or actually hold the camera high over his head so that the videographer can get a video shot of the entire crowd. However, the use of these methods in many, if not most situations, can be difficult due to many factors including, but not limited to, aesthetics and safety reasons. Clearly, at least for the reasons described above, there is a need for a device such as the Elevator.

### SUMMARY OF THE INVENTION

It is an object of the embodiments of the present invention to create an apparatus that rests on both of the videographer's shoulders thereby evenly distributing the video camera's weight over the videographer's body.

It is another object of the embodiments of the present invention to create an apparatus that increases a videographer's peripheral vision.

It is yet another object of the embodiments of the present invention to more easily increase the height of the video shot since the Elevator rests on a videographer's shoulder. The height advantage that the Elevator gives the camera also raises the lighting above the average person's line of vision.

### BRIEF DESCRIPTION OF THE DRAWINGS

FIG. 1 shows a view of an embodiment of the present invention, in front of a videographer.

FIG. 2 shows a view of an embodiment of the present invention, from the left side of a videographer, looking at the videographer's left shoulder.

FIG. 3 shows a view of an embodiment of the present invention, in back of a videographer.

### DETAILED DESCRIPTION OF THE INVENTION

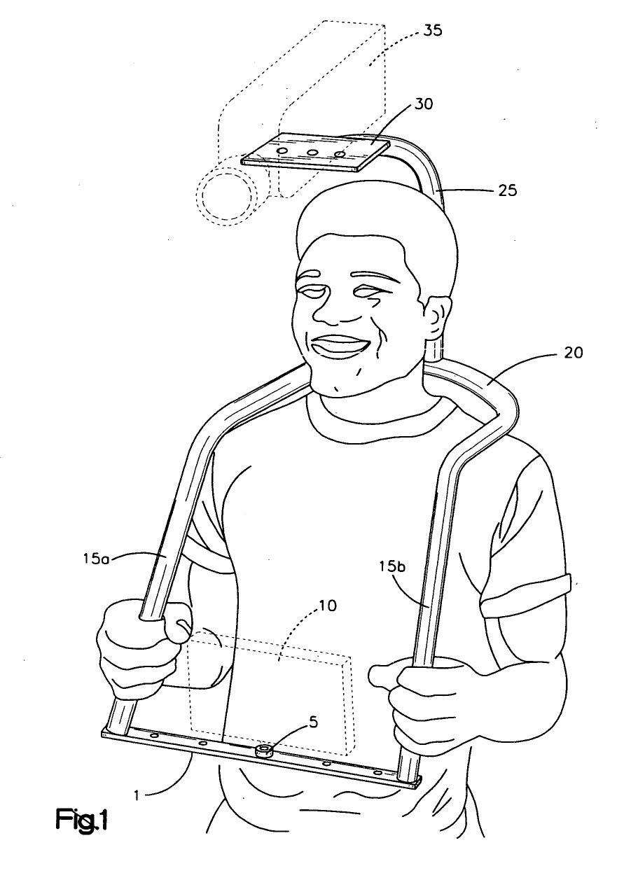

FIGS. 1-3 show an embodiment of the present invention referred to by the inventor as the “Elevator” because of the product's ability to raise a videocamera above a videographer's head, for ease of shooting a particular video-related event such as a wedding or similar celebration.

FIGS. 1-3 show embodiments of the present invention. The Elevator comprises a lower horizontal cross member 1 having a means 5 for mounting a video monitor 10, forwardly extending handle bars 15, a generally “U” shaped shoulder member 20, an upper vertical member 25 extending from a general center area of the generally “U” shaped shoulder member 20, the upper vertical member 25 having a mounting plate 30 at one end for mounting a videocamera 35.

Each section of the Elevator is generally tubular, preferably 1-to-2 inches in diameter, having a hollow interior, and can be made of steel, carbon fiber, fibertech, high-strength plastic, aluminum or other durable, yet lightweight, materials. The hollow interior of the various tubular sections allow electrical and control wiring to travel therein to facilitate providing power to the monitor and camera, and also to allow the videographer to include toggle mechanisms or related control mechanisms (not shown) on the handle bars 15 to control the camera's 35 movement.

The lower horizontal cross member 1 is preferably 16-24 inches long and includes an end at each side for connection to the forwardly extending handle bars 15. The lower horizontal cross member 1 includes a means 5 for mounting a monitor generally in a middle section thereof, said means 5 for mounting generally including a female connection for connecting to a female connection located on the monitor. In use, the lower horizontal cross member 1 generally traverses the videographer's stomach area, as shown, e.g., in FIG. 1. Although the lower horizontal member may be tubular, it is preferably flat, ⅛-inch thick, preferably 16 inches long, and preferably has a single ¼-inch hole drilled in its center.

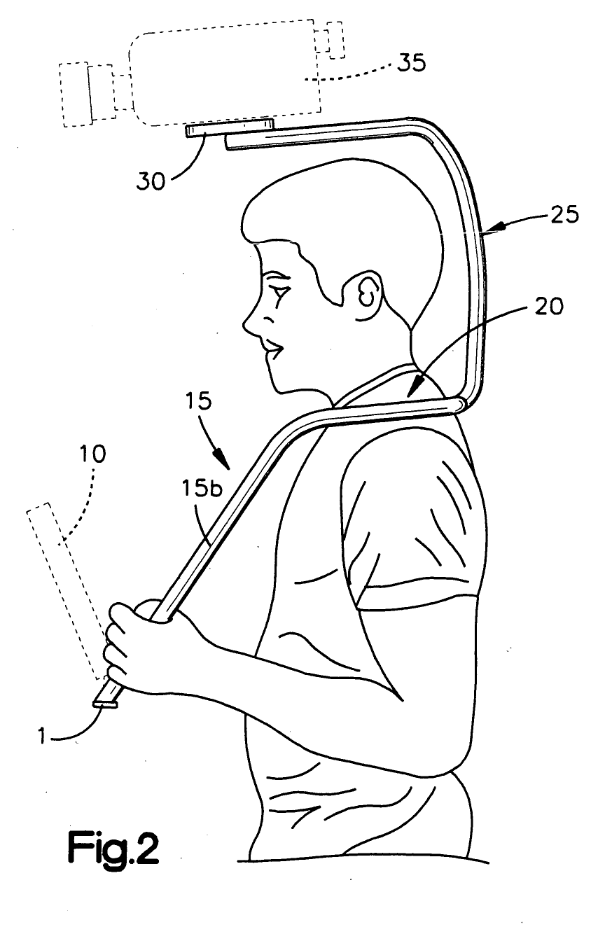

The forwardly extending handle bars 15 are preferably 16-20 inches long, and include lower and upper ends, the lower ends being connected to the lower horizontal cross member 1 and the upper ends being connected to the generally “U” shaped shoulder member 20; as shown in FIG. 2, the preferred angle at connection is preferably 65 degrees from the Y axis, but such angle may vary accordingly or from the x-axis, be an obtuse angle between the shoulder member 20 and handle bars 15. Although not shown, the forwardly extending handle bars 15 can include grips means to facilitate a videographer's gripping of the Elevator and movement thereof. In addition, the forwardly extending handle bars 15 can also include control and other toggle mechanisms connected to the electrical and control wiring, to, e.g., control the movement of the videocamera. In use, the forwardly extending handle bars 15a and 15b generally traverse from the videographer's stomach area to the videographer's left and right shoulder area, respectively.

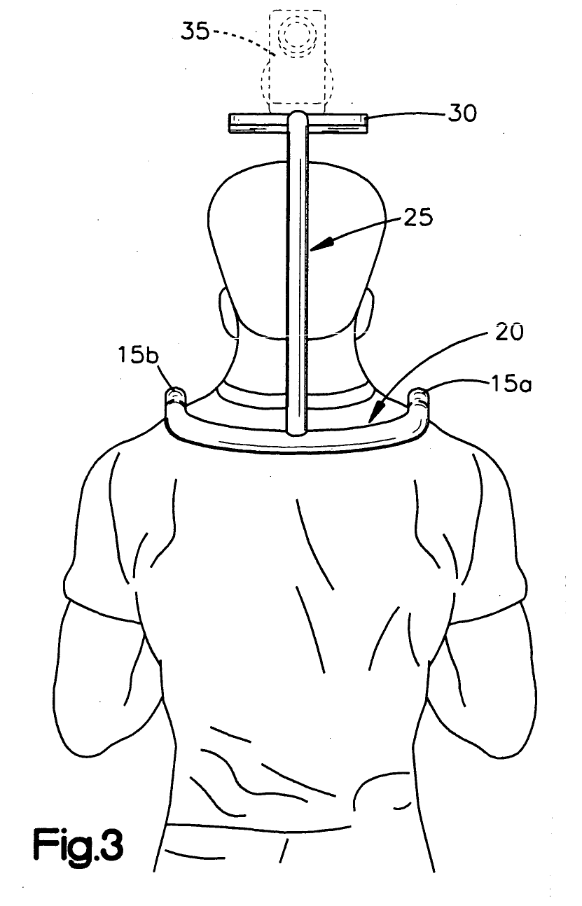

The “U” shaped shoulder member 20 is preferably 20-28 inches long, and includes ends that connect to upper ends of the forwardly extending handle bars 15, as shown, e.g., in FIG. 1. Although not shown, the “U” shaped shoulder member 20 may include attachments such as, e.g., a light or related fixture for illuminating a certain area. The “U” shaped shoulder member 20 preferably includes a shape shown in FIG. 2, but may also include a known in the art C-shaped bend around the shoulder area for additional comfort, as shown in FIG. 3. The shoulder area could also include shoulder pads and related support means as additional comfort for the videographer.

The handle bars 15 and shoulder member 20 are described above as separate sections for ease of understanding. It is understood, however, that the handle bars 15 and shoulder member 20 could be made as one member having the shape and sizes as described above. Similarly, each of the lower horizontal member, vertical legs, a shoulder member; and upper vertical member are described separately herein and connected by known in the art means as welding, etc. However, an overhead camera support apparatus having these features could also be made as one unitary unit by a molding process known to those skilled in the art. As used herein, “unitary” means one complete unit, not separated by any breaks in the various sections.

The upper vertical member 25 is preferably 12-20 inches long, and includes a forwardly extending curvature that has a mounting plate 30 at one end for mounting a videocamera 35. The upper vertical member 25 connects at one end to a general center area of the generally “U” shaped shoulder member 20. The camera mounting plate 30 preferably has a rectangular shape, is preferably 5-inches wide, 12-inches long, and ⅛-inch in thickness. Three preferably ½-inch holes (as shown in FIG. 1) are drilled into the camera mounting plate 30 to facilitate the mounting of a camera 35 and/or other related accessories, such as lights, microphones, wireless microphone receivers, power adaptors, and the like. The camera mounting plate 30 plate is preferably welded to a free end of the upper vertical member 25; however, another embodiment of the Elevator (not shown) may include a known in the art swivel, universal mechanism that connects the upper vertical member 25 to the mounting plate 30, the universal member allowing the mounting plate 30 to rotate at least 90 degrees in either direction to allow the videographer to videotape events at his side without moving his body in that direction. In use, the mounting plate 30 is preferably generally positioned above the monitor 10 located on the lower horizontal member 1. The upper vertical member 25 may also include a battery mount (not shown) positioned in the middle thereof for mounting a battery thereon.

To use, a videographer simply mounts a camera 35 to the camera mounting plate 30, attaches a monitor 10 to the lower horizontal arm 1, and raises the Elevator over his head, allowing each shoulder pad to rest on his shoulders so that the monitor 10 is in front of the videographer. As mentioned above, remote controls or related devices that facilitate the use of the camera can be attached to the various members to facilitate the apparatus' use.

Each angle shown in FIGS. 1-3 and described above may be articulating, meaning that any angle may be able to be adjusted by having a known in the art connecting means at the point where the angle starts; said connecting means allowing the angle to vary based on a user's needs.

Each connection between the lower horizontal cross member 1, forwardly extending handle bars 15, generally “U” shaped shoulder member 20, and upper vertical member 25 is preferably made by a weld; however, other know in the art methods of connection such as by male and female connections may also be used and considered as part of the embodiments of the present invention; such connections would facilitate the Elevator's use and any transport related to same. When assembled, a generally continuous, unitary member including the lower horizontal cross member 1, forwardly extending handle bars 15, generally “U” shaped shoulder member 20, and upper vertical member 25 forms the Elevator.

For purposes of claim interpretation, in particular, interpretation of means-plus functions in accordance with 35 U.S.C. §112, sixth paragraph, the lower horizontal cross member 1 is referred to as the means for horizontal support or horizontal means; the forwardly extending handle bars 15 are referred to as means for handling or handle means; the generally “U” shaped shoulder member 20 is referred to as the means for shoulder support or shoulder means; the upper vertical member 25 is referred to as the means for vertically supporting a camera or vertical support means; the monitor mount is referred to as the means for mounting the monitor or monitor mount means; the camera mount is referred to as the means for mounting the camera or camera mount means; and the grips on the forwardly extending handle bars 15 are referred to as the means for gripping or grip means.

Method of Making: The welding, assembling, bending of carbon fiber, fibertech, high-strength plastic or aluminum and manufacturing of the various embodiments of the Elevator was done by a machinist of ordinary skill in the art based on, e.g., the features of the Elevator as described above. It is clear, however, that the Elevator is not limited to the size and composition of materials described above. The Elevator, as understood by someone of ordinary skill in the art, could also be made by obtaining prefabricated molds of all or some of the components, such components being assembled thereafter by using known in the art securing or connecting means.

The word “preferably” is used throughout the specification to satisfy the best mode requirement as required by 35 U.S.C. §112, first paragraph; it is not meant in any way to limit the scope of the embodiments of the present invention.

It is clear that other embodiments of the present invention can be contrived by someone of ordinary skill simply by changing the angular relationship of some of the sections of the Elevator as described above. However, such embodiments are considered to be part of the present invention.

I claim:

1. An overhead camera support apparatus comprising:
a lower horizontal member having a first end and a second end;
at least two vertical legs, each leg having an upper end and a lower end, the lower end of each of said at least two vertical legs being connected to the first end and the second end of said lower horizontal member;
a shoulder member having a general U-shape, and third and fourth ends connected to the upper end of each of said at least two vertical legs; and
an upper vertical member connected to said shoulder member.

2. The apparatus according to claim 1, wherein said lower horizontal member includes a flat plate having a hole generally in the center of the flat plate.

3. The apparatus according to claim 1, wherein said lower horizontal member, said at least two vertical legs, said shoulder member and said upper vertical member are tubular.

4. The apparatus according to claim 3, wherein the tubular portions are hollow.

5. The apparatus according to claim 1, wherein an angle between each leg and said shoulder member includes an obtuse angle.

6. The apparatus according to claim 1, wherein each leg includes a grip means.

7. The apparatus according to claim 1, wherein the lower end of each of said at least two vertical legs is connected to the first end and the second end of said lower horizontal member, the third and fourth ends are connected to the upper end of each of said at least two vertical legs, and the upper vertical member is connected to said shoulder member by a weld.

8. The apparatus according to claim 1, wherein said apparatus is unitary.

9. The apparatus according to claim 1, wherein said upper vertical member is connected to said shoulder member in a general center location of said shoulder member.

10. The apparatus according to claim 1, wherein a free end of said upper vertical member includes a forward curvature.

11. The apparatus according to claim 1, further comprising a camera mounting plate connected to a free end of said vertical member.

12. An overhead camera support apparatus comprising:
a lower horizontal member having a first end and a second end, said lower horizontal member including a flat plate;
at least two vertical legs, each leg having an upper end and a lower end, the lower end of said at least two vertical legs being connected to the first end and the second end of said lower horizontal member;
a shoulder member having a general U-shape, and third and fourth ends connected to the upper end of each of said at least two vertical legs; and
an upper vertical member connected to said shoulder member, the connection being in a general center area of said shoulder member,
wherein said at least two vertical legs, said shoulder member and said upper vertical member include a tubular, hollow shape.

13. An overhead camera support apparatus comprising:
a means for horizontal support of a monitor;
a means for handling said apparatus;
a means for shoulder support of a videocamera; and
a means for vertical support of the videocamera.

14. The apparatus according to claim 13, further comprising a means for mounting the monitor.

15. The apparatus according to claim 13, further comprising a means for mounting the videocamera.

16. The apparatus according to claim 13, further comprising a means for gripping said handling means.

17. The apparatus according to claim 1, wherein a connection point of the lower end of each leg to the first end and the second end of said lower horizontal member is forward of the connection point of the upper end of each leg to the third and fourth ends of said shoulder member.

18. The apparatus according to claim 10, wherein said upper vertical member, in use, is positioned above a user's head.

19. The apparatus according to claim 4, wherein electrical and control wiring are disposed in the hollow tubular portions.

20. The apparatus according to claim 1, wherein said shoulder member includes a straight or general “C” shape.
